(19) United States
(12) Patent Application Publication
(10) Pub. No.: US 2008/0104023 A1
(43) Pub. Date: May 1, 2008

(54) METHOD AND APPARATUS FOR READING DOCUMENTS AND ANSWERING QUESTIONS USING MATERIAL FROM THESE DOCUMENTS

(75) Inventor: Nicholas William Dawes, Ottawa (CA)

Correspondence Address: Dennis R. Haszko;Patent Law Office of D.R.Haszko, 499 MOSHER HILL ROAD, FARMINGTON, ME, 04938-5405, US

(73) Assignee: DPDatasearch Systems Inc., Ottawa (CA)

(21) Appl. No.: 11/566,361

(22) Filed: Dec. 4, 2006

Related U.S. Application Data
(60) Provisional application No. 60/863,178, filed on Oct. 27, 2006.

(51) Int. Cl. G06F 17/30

(52) U.S. Cl. 707/3

(57) ABSTRACT

A method and apparatus that provides the reading of text from documents and the extraction of key information from this text along with the use of this key information to answer questions posed by a user by presenting the most relevant sentence in the text in reply to the user's query. Based upon selectivity methodologies, the method and apparatus provides for search and retrieval based upon natural language inquiries with an increase in accuracy and efficiency.

### CROSS REFERENCE TO RELATED APPLICATIONS

This application claims priority from U.S. Provisional Patent Application Ser. No. 60/863,178 filed on Oct. 27, 2006, the contents of which are herein incorporated by reference.

### FIELD OF THE INVENTION

The present invention relates generally to database searching and analysis. More particularly, the present invention relates to a method and apparatus for analyzing stored information and answering questions based upon such stored information.

### BACKGROUND OF THE INVENTION

Within the field of text searching, it is generally known that a database can be automatically searched using search terms typically characterized as keywords. For example, current methods of Internet-based searching includes search engines such as Google.com which return the most popular web-page containing the keywords typed by a user into a search query. However, the keywords on any given web-page often have no relationship to the other keywords in the search such that the search results returned can be misleading or even irrelevant.

It is, therefore, desirable to provide a mechanism that improves upon existing database searching and analysis.

### SUMMARY OF THE INVENTION

It is an object of the present invention to obviate or mitigate at least one disadvantage of previous database searching and analysis mechanisms.

In a first aspect, the present invention provides a method for responding to a question posed by a user, the method including: decomposing a source into an ordered group of constituent parts; changing the question posed by the user into a keyword search; selecting text from the decomposed source based upon predetermined criterion and the keyword search; and presenting the selected text to the user to answer the question posed by the user.

In a second aspect, the present invention provides an apparatus for use in responding to a question posed by a user, the apparatus including: a first module for decomposing a source into an ordered group of constituent parts; a second module for changing the question posed by the user into a keyword search; a third module for selecting text from the decomposed source based upon predetermined criterion and the keyword search; and a fourth module for presenting the selected text to the user to answer the question posed by the user.

In a third aspect, the present invention provides a decomposing module for use within an information search and retrieval mechanism that responds to a question posed by a user, the decomposing module including: a first sub-module for breaking a source including one or more documents into an ordered group of constituent parts including a hierarchy of headings, statements, and words found within each the one or more documents; and a second sub-module for transforming tabular data within the source into column names, row names, and cell contents.

In a fourth aspect, the present invention provides a changing module for use within an information search and retrieval mechanism that responds to a question posed by a user, the changing module including: a first sub-module for breaking the question posed by the user into keywords; a second sub-module for replacing expanded forms of acronyms found within the question with their corresponding acronym; a third sub-module for retaining information corresponding to an order of words presented within the question; a fourth sub-module for retaining information corresponding to a probable sense of a class of answer expected to the question; and a fifth sub-module for transforming a number presented in the question in any form into that number and a keyword defined as “number”.

In a fifth aspect, the present invention provides a selecting module for use within an information search and retrieval mechanism that responds to a question posed by a user, the selecting module including: a first sub-module for ranking keywords decomposed from text of the question; and a second sub-module for applying keyword selectivity for each the keyword defined as M/N where N is a number of occurrences for each keyword and M is a total number of statements within a decomposed source; wherein the first and second sub-modules selects text from the decomposed source based upon the ranking and the keyword selectivity.

In a sixth aspect, the present invention provides a presenting module for use within an information search and retrieval mechanism that responds to a question posed by a user, the presenting module including: a first sub-module for showing selected text to the user preceded by an indication of hierarchy of the selected text; a second sub-module for showing the selected text to the user along with related text immediately preceding and following the selected text from a decomposed source; and a third sub-module for providing a link to a current full context of the selected text; such that the first, second, and third sub-modules present selected text to the user so as to answer the question posed by the user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a generalized flowchart of the different modules in accordance with the present invention.

FIG. 2 is a screenshot showing an example of an output provided by the method and apparatus of the present invention.

### DETAILED DESCRIPTION

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. Such interconnection may include the Internet or a more localized network such as a Local Area Network (LAN). The implementation is a matter of choice dependent on the performance requirements of the computing system implementing the invention. Accordingly, the logical operations making up the embodiments of the invention described herein can be variously referred to as operations, steps, or modules.

Generally, the present invention provides a method and apparatus for analyzing stored information and answering questions based upon such stored information. Moreover, the invention supports the reading of text from documents, the extraction of key information from this text, and the use of this key information to answer a user's questions by presenting the most relevant sentence in the text in reply to the user's query. The present invention as herein described greatly improves upon earlier database search and retrieval techniques with several inventive aspects.

It should be understood that many details including the stored information to be searched is itself within the general known state of the art such that these details should be readily apparent to one of ordinary skill in the database search and retrieval art. Accordingly, details concerning information storage are not discussed herein.

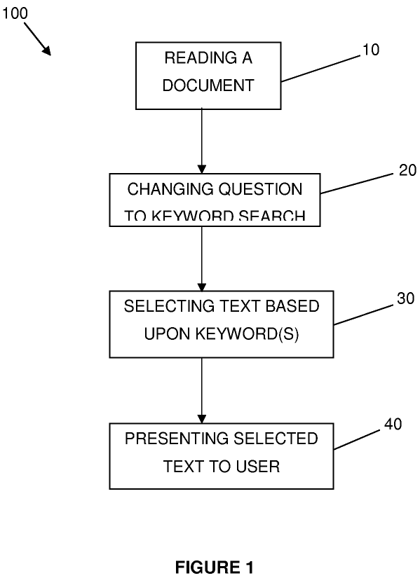

As shown in FIG. 1, the present invention 100 includes four basic aspects that may be considered in terms of four programming modules 10, 20, 30, 40 that each include unique characteristics and together provide a unique system for database search and retrieval. The first module 10 includes programming that executes a method of reading a document. The second module 20 includes programming that executes a method of changing a question into a keyword search. The third module 30 includes programming that executes a method of selection of text. The fourth module 40 includes programming that executes a method of presenting such selected text. As mentioned, each module includes distinct aspects that are considered usable both independently and in combination. For clarity of description, such the invention will be discussed in terms of a method although the term modules or operations may be equally descriptive of the present invention without straying from the intended scope nor otherwise limiting the intended patent coverage.

The present invention is very practical in terms of the time consumed by performing the methods involved. For example, a document can be considered to be a book containing an average of 700 pages. The present invention is applicable to document sizes ranging from 1 book to 8000 books where the present invention can very quickly read through such documents and can achieve highly accurate question answering. Indeed, contemporary computers typically produce an answer to a user's question in an average of less than 2 second from an 8,000 book source. In tests based upon the present invention, success was determined when the desired result was presented within the top three answers returned.

For purposes of the present invention, several terms will be defined herein.

A “document” is any text, with or without internal structure indicated by markup or in any other way. Examples are files created by editors, PDF files, HTML, or Wikipedia content files.

A “heading” is any part of a document that is indicated by any manner to refer to or describe in any manner the contents of the document that follow. A heading therefore includes the usual section or subsection headings, but also includes titles of tables and captions for figures or diagrams.

A “statement” is any part of a document whose start and end are marked in some regular manner. Terminations could be by sentence termination markings (e.g., a period followed by a space), or by paragraph start or end markings (e.g., a blank line) or by some other method (e.g., a line drawn across the page or a marker for the end of a page or the start of some other material).

A “word” includes its usual meaning, but also includes any sequence of characters (alphabetic or otherwise) whose start and end in a sequence of characters can be determined by any method.

A “keyword” is any word which is recorded as being used or referencing a portion of text. Examples of a keyword are: “anchor”, “1984”, “3.14159”, “3-ply”, “UDP” or the like.

A “source” is one or more documents whose contents are read and from which questions can be answered.

The term “keyword selectivity” is the selectivity of a keyword which occurs in N of the M statements in the source, where N and M are expressed as positive integers and selectivity is expressed as M/N. However, if a keyword is very often capitalized or has been capitalized in the question, such keyword is given a much larger selectivity equal to (M/N multiplied by K) where K≧1. Such larger selectivity may further be increased by adding L to (M/N multiplied by K) where L>>1. It should be noted that both manners of increasing the selectivity may be used such that a much larger selectivity may be obtained by multiplying M/N by K and then adding L. In such instance, K would be a lower value. In this unique and innovative manner, such capitalized keywords are allowed to dominate a search.

The term “statement selectivity merit” is the product of the keyword selectivities of all the keywords in that statement. Such formulation of statement selectivity based on the keyword selectivity is also considered a unique and innovative aspect of the present invention.

The term “stem” is the base word that appears in the text of the source or question as presented by the user. All other words may be mapped to their corresponding stem if such stem is known or deducible. An example of such would be that “prevent” is the stem of: prevents, prevented, preventing, preventative, preventive, and prevention. Similarly, acronyms or abbreviations can be stems such as “ARP” can be the stem of: ARPs or ARPing, whereby the lowercase after ARP can be useful in identifying the stem ARP.

Within the scope of the present invention, each module combines to provide an innovative search and retrieval system. In general terms of operation with regard to the definitions listed above, the present invention captures structural content from the document such as headings and uses this in question answering. The questions to be answered are presented by a user by way of a graphical user interface (GUI). Such GUI should be understood to be well known in the art of Internet searches. While Internet-based searches are mentioned herein, it should further be understood that any LAN or standalone searching may also benefit from the present invention. The questions presented by the user can be phrased in natural language (e.g., Did Galileo experiment from the Tower of Pisa?) and are processed by unique methods to produce partially comprehended equivalents which are then used in search. The searching comprehends tables by mapping of the appropriate column and row name from a table into a set of keys associated with the content of each cell in the table. Selectivity of such keys is handled uniquely in a probabilistic manner. Multiple answers to a user's question are analyzed by way of integration of several selection methods and such answers are presented as a list of ranked results.

The first module 10 includes programming that executes a method of reading a document. As mentioned above, such documents may be stored in any known manner whereby the details of such are considered to be well known to one of ordinary skill in the art and not discussed further herein. Reading of a document consists of analyzing the document and includes the use of a central processing unit (CPU) within one or more computers connected in any known manner to a storage device where such document is stored. In operation, a document will be read in order to decompose the text into a hierarchy of headings, statements, and words. In a first pass, all new words and acronyms included in the document are acquired. In a second pass, a reading will occur in order to process such headings, statements, and words. Although a document is usually read twice in this manner, it should be understood that a static document that has already been initially read and decomposed will not normally require a two step reading. In such instance, only the second pass would be needed. However, from time to time, it is realized that any given document may be updated by the document author. In such instances, it should be readily apparent that another two step reading (i.e., initial pass for decomposing new text and second pass for processing) would be entirely appropriate and needed to ensure all current text is considered.

As already mentioned, the one or two passes within the first module 10 decompose the text into a hierarchy of headings, statements, and words. In the first pass, the system acquires all the new words and acronyms included in the document. If a document is considered to have an insignificant number of new words or acronyms, the previously recorded set of words and acronyms can be used and this first pass skipped. Words are always mapped onto their stems during this process (e.g., “based” is mapped onto “base”) and then capitalized.

In the second pass, the first module 10 records the words used in each statement, the keys corresponding to each statement, and the most recent heading statements for that statement. Numbers in any form generate not only the keyword for that number but also the general keyword “number”. Additionally, when questions such as “how many . . . ?” are presented by a user, they also generate the same general keyword “number.” Similarly, any word associated with time (e.g., January or 1986) causes the general keyword “time” to be associated with the statement in which that word occurs. Still further, any word or word phrase associated with cause or effect (e.g., “therefore” or “it follows that” or “because”) causes the general keyword “cause” to be associated with the statement in which that word or word phrase occurs. Similar general keywords as necessary may exist without straying from the intended scope of the present invention.

During the decomposition process within the first module 10, tabular data is decomposed into column names, row names, and cell contents. The contents of each cell are stored as a statement with the appropriate column name and row name also used as keys into that statement. Acronyms are recognized either by the structure of the statement or because they are listed as such in a table, appendix, or in some other logical manner. For example, the sequence “UDP (Universal Data Protocol)” would be recognized as the definition of an acronym. The three capital letters in UDP correspond to the leading letters in the sequence of words contained in the brackets immediately following. When acronyms are met in the second pass in their expanded form (e.g., “Universal Data Protocol”), this sequence is replaced by the acronym. Similarly, the expanded forms found in questions (as discussed in regard to the second module 20) presented by the user are replaced by the corresponding acronyms. In this way, differences in acronym use as expanded or contracted forms between statements and questions are abolished. Upon completion of the reading step of the first module 10, the second module 20 serves to change the question presented by the user into a keyword search.

The second module 20 includes programming that executes a method of changing a question into a keyword search. As mentioned, questions can be posed by the user in natural language. Alternatively, the user may present a series of key words. It is important to note that the order of words in a natural language question inherently carries a great deal of the sense of the question. The present invention utilizes the order of the words in a unique manner. For example: “What can solve equations?” is not the same as “What can equations solve?” The ordering of the words in the question is therefore retained by the second module 20 so that such order may be used in the search by the innovate methods embodied within the third module 30.

It should be understood further that questions often specify the class of answer expected. For example, the question “How many . . . ?” implies that an answer with a number is expected. Therefore, “How many . . . ?” generates the general keyword “number”, which is created by all numbers met in the text (which was earlier decomposed by the first module 10). Further, a question like “What is calculus?” usually seeks a definition. In such instance, a header or a statement in a table of definitions may be more appropriate as an answer. A heading is stored with the keyword “definition” linked to it. This mapping of each question in the second module 20 generates a keyword (or keywords) used in searches corresponding to the probable sense of that question.

During the process within the second module 20, it should be recognized that the formulation of keyword selectivity for capitalized words allows such words dominate any subsequent search of the text. For example, it is far more important that an answer refer to “UDP” than to “purpose” or “function” for the question “What is the purpose and function of UDP?” This is another unique manner in which the sense of the question is mapped onto the keyword search through the present invention.

The third module 30 includes programming that executes a method of selection of text. In general, such selection method is based on the question keywords. All statements suggested by the keywords in the question are ranked by their statement selectivity merit as has been defined above. A higher ranking corresponds to a higher statement selectivity merit. Further, each keyword may include a stem. For instance, a keyword in the user's question may be “prevention” and therefore the stem “prevent” might be known or deduced by the present invention such that the terms “prevents, prevented, preventing, preventative, and preventive” would be sought via the third module 30 in addition to the keyword “prevention.”

By way of the explanation hereinbelow, it should therefore be readily apparent that the third module 30 selects text based upon the keywords in a manner that greatly differs from the simple use of all the keywords on a page as is currently known in the database search and retrieval art. Such differences include the use of keyword selectivity, the use of pairing and sequence detection, and the modification of selectivity of heading keywords in statements that follow the heading. More specifically, the statement selectivity merit may be modified based upon other conditions.

One such condition arises in the instance of definitional statements that can be penalized if they contain excessive words. For example, it should be understood that the heading “Fluent calculus” should be rejected from a search of the decomposed text when answering the question “What is calculus?” because the definition of calculus is unlikely to be found under the heading “Fluent calculus” which has excessive words beyond calculus.

Another such condition may arise where all the pairs of keywords in the question are compared to all pairs of keywords in the matching statement. If a pair match is made, the statement selectivity merit is increased by the sum of the keyword selectivities times a constant. Alternatively, such sum of the keyword selectivities can be added to a constant. It should be apparent therefore that a significant portion of the keyword sequencing in the question is used in statement selection. Because word sequencing carries a significant portion of the sense of natural language, the present invention captures correspondence in sense between question and statements. Alternative extensions to other sequence correspondences can be also be used without straying from the intended scope of the present invention. An example of where this sequencing is of help is as follows. Suppose the question is “What is collaborative computing?” The statement “People who collaborate often share computing facilities” will not be rewarded by the pair match of “collaborative”+“computing”. The statement “collaborative computing involves the use of . . . ” does have the exact match and will be rewarded with an increased statement selectivity merit.

Modification of the statement selectivity merit may further occur in the condition where a heading statement is considered but lacks certain keywords in the question. In such instance, the statements below that heading can be examined for those extra keywords. This corresponds to carrying the keys from the heading forward over the scope of that heading. However, the keyword selectivity of keys carried forward is reduced from their present value in regards to the statement itself. Consider the question “When is Queen Elizabeth's birthday?” The heading could be “Queen Elizabeth” and a statement in the paragraph below could state “Her birthday is . . . ”. This is a less precise statement than one such as “Queen Elizabeth's birthday is . . . ”, but would be matched best in the absence of such a more precise statement.

Additional to the method of selection of text discussed above, there are two further mechanisms that can be used to further select the best text in response to the question presented by the user. One is the obvious-match, parallel-selection method and another is the synonym parallel selection method.

In the obvious-match, parallel-selection method a statement can be selected on the basis that it matches all the keywords or a large number of keywords. If such a statement would not be best selected by the statement selectivity merit methodology mentioned above and is found to be an obvious-match, then such match is chosen and returned to the user. It should be readily apparent however that only some questions get such an obvious-match. Because this method is orthogonal to the statement selectivity merit methodology above, any such suggested statement will be placed top (or in the top few) on the ranking, above all of those of the statement selectivity merit methodology.

In the synonym parallel selection method, often a statement will be considered but lacks certain keywords in the question. Each of the missing keywords is considered with respect to each of the unmatched keywords in the statement. In the synonym parallel selection method, the shortest synonym path from each missing keyword to any unmatched keywords in the statement is found up to X hops, where X is an integer greater than 1. A synonym path is a sequence of hops. In general, 1 or 2 hops are suitable. However, in a more exacting nomenclature less interested in synonyms (e.g., chemistry) the maximum number of hops permitted may be less than in a less exacting nomenclature (e.g., law or politics). As such, it should be understood that the maximum number of hops X is chosen in an empirical manner and may vary without straying from the intended scope of the present invention.

In operation of the synonym parallel selection method, each hop steps from a word to all synonyms of that word. Therefore, a span of 1 hop from a word such as “ring” would include the synonym “circle”. The next hop from “circle” would include a word such as “surround”. The selectivity of the missing keyword is then added to the statement selectivity merit, reduced by F(X) where F(X) is a function such as follows. The selectivity of a keyword which occurs in N of M statements in the source document is M/N. If X is 2 (for the given nomenclature) then this selectivity equals (square root of M)/N. If X=3, then this selectivity equals (cubed root of M)/N, and so on for increasing values of X. Other functions dependent on X which modify the keyword selectivity can also be used. Examples of such functions are division by X, or multiplication by K where K is a constant for a particular value of X.

In regards to the synonym parallel selection method, there are two ways for integrating synonym matching into the ranking process discussed above. Either all statements are ranked by their statement selectivity after synonym matching, or the best synonym matched statement is selected and placed at the top (or in the top few) of the statement ranked as above. Upon completion of the selection of text by the third module 30, the ranked results are presented to the user via the GUI in the fourth module 40.

The fourth module 40 includes programming that executes a method of presenting such selected text. As discussed above, a great deal of information about a statement is held in the hierarchy of headings above it. For example, the page title and section title say a lot about a statement. Therefore each statement shown to the user is preceded by a line defining this hierarchy. The statement is then shown to the user usually with the preceding and following text if room permits, or may be modified as chosen by the user. This unique presentation of the heading hierarchy greatly assists a user when scanning results from vague questions. Clicking on this heading hierarchy causes the full context of the statement in the document to be shown (e.g., it shows the web page, with the statement position indicated or scrolled to).

It should further be understood that documents can of course change between the time when they were initially read by the inventive system (at the first module 10) and the time when the user asks a question. Should the original statement have moved, the most detailed extant heading in the hierarchy for the selected statement will now be the target shown when the user clicks on the heading to show the full context of the statement.

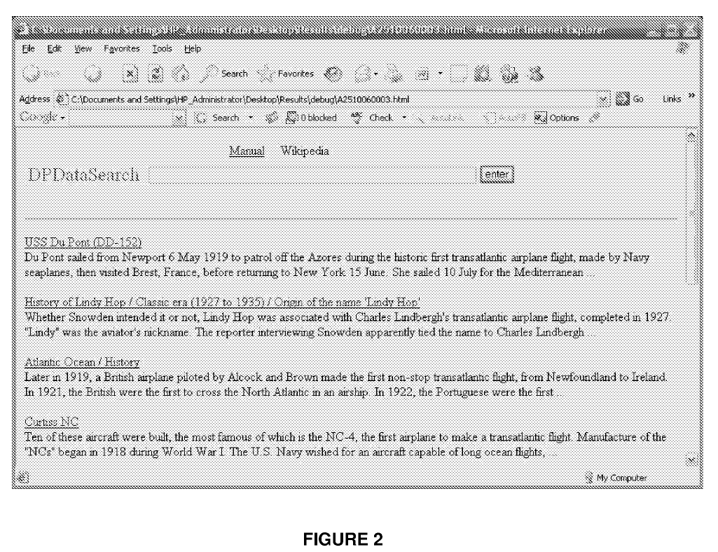

FIG. 2 shows one such example of an output of the fourth module 40. Specifically, the results shown are the responses generated in reply to the question “When was the first transatlantic airplane flight?” From the results shown, it can be seen that an emphasis was placed on dates due to the “When” found in the question presented by the user in this example. The emphasis comes from the leading “When” being detected by the second module 20 as the start of a time-related question, so the question generates the “time” keyword while dropping the “When” word itself. During document processing (the second pass mentioned in regard to the first module 10), the dates (e.g., 1919) in the statements generated both the “time” keyword and the associated number (e.g., 1919) such that the “time” keyword from the question selected these statements above statements with no time indications. Still further, it can be seen that ranking using exact matches to word pairs is used in the ordering of the list. In particular, “first transatlantic airplane flight” occurs in the top answer whereas “transatlantic airplane flight” and “first” with “transatlantic flight” are returned lower down in the ranking of answers.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1) A method for responding to a question posed by a user, said method comprising:
decomposing a source into an ordered group of constituent parts;
changing said question posed by said user into a keyword search;
selecting text from said decomposed source based upon predetermined criterion and said keyword search; and
presenting said selected text to said user to answer said question posed by said user.

2) The method as claimed in claim 1 wherein said keyword search includes keywords decomposed from text of said question.

3) The method as claimed in claim 2 wherein said predetermined criterion includes keyword selectivity for each said keyword defined as M/N where N is a number of occurrences for each keyword and M is a total number of statements within said source.

4) The method as claimed in claim 3 wherein said keyword selectivity M/N is multiplied by a constant K>=1 for any capitalized ones of said keywords.

5) The method as claimed in claim 4 wherein said keyword selectivity M/N multiplied by said constant K is further subjected to an addition of a constant L>>1 for any capitalized ones of said keywords.

6) The method as claimed in claim 3 wherein said predetermined criterion further includes statement selectivity merit defined as the product of said keyword selectivities of all said keywords in a corresponding one of said statements within said source.

7) The method as claimed in claim 1 wherein said source includes one or more documents and said ordered group of constituent parts includes a hierarchy of headings, statements, and words found within each said one or more documents.

8) The method as claimed in claim 7 wherein said decomposing step further includes recording said words used in each said statement, keys corresponding to each said statement, and a most recent heading statement for each said statement.

9) The method as claimed in claim 8 wherein said decomposing step further includes recording keys corresponding to each said statement.

10) The method as claimed in claim 9 wherein said decomposing step further includes storing a most recent heading statement for each said statement.

11) The method as claimed in claim 1 wherein said changing step further includes transforming a number presented in said question in any form into that number and a keyword defined as “number”.

12) The method as claimed in claim 1 wherein said changing step further includes transforming any word related to time presented in said question in any form into that time and a keyword defined as “time”.

13) The method as claimed in claim 1 wherein said changing step further includes transforming a cause or effect word or word phrase presented in said question in any form into that cause or effect word and a keyword defined as “cause”.

14) The method as claimed in claim 1 wherein said decomposing step further includes transforming tabular data within said source into column names, row names, and cell contents.

15) The method as claimed in claim 14 wherein said cell contents are stored as a statement with corresponding ones of said column names and row names used as keys into said statement.

16) The method as claimed in claim 1 wherein said decomposing step further includes replacing expanded forms of acronyms found within said source with their corresponding acronym.

17) The method as claimed in claim 1 wherein said changing step further includes replacing expanded forms of acronyms found within said question with their corresponding acronym.

18) The method as claimed in claim 1 wherein said changing step further includes retaining information corresponding to an order of words presented within said question.

19) The method as claimed in claim 1 wherein said changing step further includes retaining information corresponding to a probable sense of a class of answer expected to said question.

20) The method as claimed in claim 3 wherein said statement selectivity merit of any definitional statements found within said source is reduced when said definitional statement includes excessive words.

21) The method as claimed in claim 6 wherein said selecting step further includes comparing all pairs of keywords in said question to all pairs of keyword pairs in said statement and, upon occurrence of a pair match, increasing said statement selectivity merit by the sum of said keyword selectivities times a constant.

22) The method as claimed in claim 6 wherein said selecting step further includes comparing all pairs of keywords in said question to all pairs of keyword pairs in said statement and, upon occurrence of a pair match, increasing said statement selectivity merit by the product of said keyword selectivities times a constant.

23) The method as claimed in claim 6 wherein said selecting step further includes comparing all pairs of keywords in said question to all pairs of keyword pairs in said statement and, upon occurrence of a pair match, increasing said statement selectivity merit by the sum of said keyword selectivities plus a constant.

24) The method as claimed in claim 1 wherein
said source includes one or more documents and said ordered group of constituent parts includes a hierarchy of headings, statements, and words found within each said one or more documents,
said predetermined criterion includes keyword selectivity for each said keyword defined as M/N where N is a number of occurrences for each keyword and M is a total number of statements within said source, and
said selecting step further includes examining said statements below a corresponding one of said headings for additional ones of said keywords when said heading is considered but found lacking certain keywords of said question.

25) The method as claimed in claim 6 wherein
said selecting step further includes examining said keywords within said statements for matching synonyms of said keywords, and
ranking all said statements by their corresponding statement selectivity after said synonym matching.

26) The method as claimed in claim 6 wherein
said selecting step further includes examining said keywords within said statements for matching synonyms of said keywords, and
selecting a best synonym matched statement for top ranking placement.

27) The method as claimed in claim 1 wherein
said source includes one or more documents and said ordered group of constituent parts includes a hierarchy of headings, statements, and words found within each said one or more documents, and
said presenting step includes showing said selected text to said user preceded by an indication of hierarchy of said selected text.

28) The method as claimed in claim 27 wherein said presenting step further includes showing said selected text to said user along with related text immediately preceding and following said selected text from said source.

29) The method as claimed in claim 27 wherein said selected text provided within said presenting step is provided by way of a uniform resource locator (URL) link to a current full context of said selected text.

30) An apparatus for use in responding to a question posed by a user, said apparatus comprising:
a first module for decomposing a source into an ordered group of constituent parts;
a second module for changing said question posed by said user into a keyword search;
a third module for selecting text from said decomposed source based upon predetermined criterion and said keyword search; and
a fourth module for presenting said selected text to said user to answer said question posed by said user.

31) The apparatus as claimed in claim 30 wherein said ordered group of constituent parts includes a hierarchy of headings, statements, and words found within each of one or more documents of said source.

32) The apparatus as claimed in claim 30 wherein said predetermined criterion includes keyword selectivity for each said keyword defined as M/N where N is a number of occurrences for each keyword and M is a total number of statements within said source.

33) The apparatus as claimed in claim 30 wherein said selected text is presented to said user along with related text immediately preceding and following said selected text from said source.

34) The apparatus as claimed in claim 33 wherein said selected text and said related text is presented to said user via a uniform resource locator (URL) link to a current full context of said selected text and said related text.

35) A decomposing module for use within an information search and retrieval mechanism that responds to a question posed by a user, said decomposing module comprising:
a first sub-module for breaking a source including one or more documents into an ordered group of constituent parts including a hierarchy of headings, statements, and words found within each said one or more documents; and
a second sub-module for transforming tabular data within said source into column names, row names, and cell contents.

36) A changing module for use within an information search and retrieval mechanism that responds to a question posed by a user, said changing module comprising:
a first sub-module for breaking said question posed by said user into keywords;
a second sub-module for replacing expanded forms of acronyms found within said question with their corresponding acronym;
a third sub-module for retaining information corresponding to an order of words presented within said question; and
a fourth sub-module for retaining information corresponding to a probable sense of a class of answer expected to said question;

37) The changing module as claimed in claim 36 further including a fifth sub-module for transforming a number presented in said question in any form into that number and a keyword defined as “number”.

38) The changing module as claimed in claim 37 further including a sixth sub-module for identifying any word associated with time and enabling a general keyword “time” to be associated with any statement in which said word associated with time occurs.

39) The changing module as claimed in claim 38 further including a seventh sub-module for identifying any word associated with cause and effect and enabling a general keyword “cause” to be associated with any statement in which said word associated with cause and effect occurs.

40) The changing module as claimed in claim 39 further including an eighth sub-module for identifying any heading associated with a definition and enabling a general keyword “definition” to be associated with said heading.

41) The changing module as claimed in claim 40 wherein any statement associated with a definition is also identified and associated with said general keyword “definition”.

42) A selecting module for use within an information search and retrieval mechanism that responds to a question posed by a user, said selecting module comprising:
a first sub-module for ranking keywords decomposed from text of said question; and
a second sub-module for applying keyword selectivity for each said keyword defined as M/N where N is a number of occurrences for each keyword and M is a total number of statements within a decomposed source;
wherein said first and second sub-modules selects text from said decomposed source based upon said ranking and said keyword selectivity.

43) The selecting module as claimed in claim 42 further including
a third sub-module for determining whether each said keyword includes a stem and identifying all words stemming from said stem,
wherein said first and second sub-modules selects text from said decomposed source also based upon correspondence to said stem.

44) A presenting module for use within an information search and retrieval mechanism that responds to a question posed by a user, said presenting module comprising:
a first sub-module for showing selected text to said user preceded by an indication of hierarchy of said selected text;
a second sub-module for showing said selected text to said user along with related text immediately preceding and following said selected text from a decomposed source; and
a third sub-module for providing a link to a current full context of said selected text;
such that said first, second, and third sub-modules present selected text to said user so as to answer said question posed by said user.
